(19) United States
(12) Patent Application Publication
(10) Pub. No.: US 2022/0123367 A1
(43) Pub. Date: Apr. 21, 2022

(54) NONAQUEOUS ELECTROLYTE SECONDARY BATTERY AND ELECTROLYTE SOLUTION USED IN SAME

(71) Applicant: Panasonic Intellectual Property Management Co., Ltd., Osaka-shi, Osaka (JP)

(72) Inventors: Yasuko Nozaki, Osaka (JP); Tasuku Ishiguro, Osaka (JP); Tomohisa Okazaki, Osaka (JP)

(73) Assignee: Panasonic Intellectual Property Management Co., Ltd., Osaka-shi, Osaka (JP)

(21) Appl. No.: 17/424,222

(22) PCT Filed: Dec. 18, 2019
(86) PCT No.: PCT/JP2019/049643

§ 371 Date: Jul. 20, 2021

(30) Foreign Application Priority Data
Jan. 31, 2019 (JP) 2019-016390

(51) Int. Cl. H01M 10/0569; H01M 10/0568; H01M 10/0567; H01M 10/0525

(52) U.S. Cl. CPC H01M 10/0569; H01M 10/0525; H01M 10/0567; H01M 10/0568

(57) ABSTRACT

A non-aqueous electrolyte secondary battery including a positive electrode, a negative electrode and a liquid electrolyte, wherein the liquid electrolyte contains lithium bis(fluorosulfonyl)imide and dimethyl sulfate.

### TECHNICAL FIELD

The invention primarily relates to an improvement of liquid electrolytes for non-aqueous electrolyte secondary batteries.

### BACKGROUND ART

Non-aqueous electrolyte secondary batteries, especially lithium ion secondary batteries, are expected as a power source for small consumer applications, power storage devices and electric vehicles because of their high voltage and high energy density. While a long life is required for batteries, it has been proposed to add lithium bis(fluorosulfonyl)imide (hereinafter, also referred to as LFSI) to the liquid electrolyte (Patent Literatures 1 and 2).

### CITATION LIST

### Patent Literature

[PTL 1] WO2014/157591
[PTL 2] WO2016/009994.

### SUMMARY OF INVENTION

However, when LFSI is used, repeating the cycle of charge and discharge of the battery during a long term increases the impedance. Considering the amount of increase in impedance, it is desirable to further reduce the initial impedance.

In view of the above, one aspect of the invention relates to a non-aqueous electrolyte secondary battery comprising: a positive electrode, a negative electrode, and a liquid electrolyte, wherein the liquid electrolyte contains lithium bis(fluorosulfonyl)imide and dimethyl sulfate.

Another aspect of the present invention relates to a liquid electrolyte for a non-aqueous electrolyte secondary battery containing lithium bis(fluorosulfonyl)imide and dimethyl sulfate.

According to the invention, an initial impedance of non-aqueous electrolyte secondary batteries can be remarkably lowered.

### BRIEF DESCRIPTION OF DRAWING

FIG. 1 shows a schematic partially cut-away oblique view of a non-aqueous electrolyte secondary battery according to an embodiment of the invention.

### DESCRIPTION OF EMBODIMENTS

A non-aqueous electrolyte secondary battery according to the invention has a positive electrode, a negative electrode, and a liquid electrolyte, and the liquid electrolyte contains lithium bis(fluorosulfonyl)imide: LiN(SO₂F)₂ and dimethyl sulfate.

Lithium bis(fluorosulfonyl)imide (also referred to as LFSI) forms a film (hereafter referred to as LFSI film) on the positive and negative electrode surfaces which is excellent in lithium-ion conductivity and inhibits degradation of the liquid electrolyte, alone or together with other components of the liquid electrolyte. LFSI film prevents the reduction in capacity maintenance ratios in an early stage of the cycles of charge and discharge.

On the other hand, repeated charge and discharge cycle of the battery during a long term may lead to an excessive reaction of LFSI at the positive electrode surface, resulting in inactivation of LFSI film as well as causing a greater impedance and a greater capacity reduction.

In contrast, dimethyl sulfate has the effect of forming an excellent film with electron conductivity on the positive and negative electrode surfaces and lowering the initial impedance. It is considered that such a film is a hybrid film containing an S-containing group derived from dimethyl sulfate and a group derived from LFSI. The formation of a hybrid film inhibits the increase in impedance at both the positive and negative electrodes, and markedly reduces the initial impedance of the battery.

The hybrid film may also suppress excessive reaction of LFSI at the surface of the positive electrode. Among them, when the positive electrode includes a positive electrode material or a positive electrode active material which may contain an alkali component such as a composite oxide containing lithium and nickel, an effect of suppressing an excessive reaction of LFSI (e.g., a reaction between LFSI and an alkali component) becomes remarkable. It is possible that the inactivation of LFSI film is suppressed and the increase in impedance is further suppressed accordingly.

The content of dimethyl sulfate in the liquid electrolyte may be, for example, 5 mass % or less with respect to the mass of the liquid electrolyte. By adjusting the amount of dimethyl sulfate contained in the liquid electrolyte as described above, the ratio of the group derived from LFSI in the hybridized film with LFSI is sufficiently secured, and the effect of suppressing the decomposition reaction of the liquid electrolyte becomes large, so that a good capacity maintenance ratio can be easily obtained. The content of dimethyl sulfate in the liquid electrolyte may be 2 mass % or less, and may be 1.5 mass % or less, with respect to the mass of the liquid electrolyte.

At least a portion of dimethyl sulfate is gradually consumed at the beginning of the charge and discharge cycles. After a sufficient hybrid film is formed on the surface of the positive electrode and the surface of the negative electrode, the content of dimethyl sulfate in the liquid electrolyte may be 10 ppm or more with respect to the mass of the liquid electrolyte, and may be 100 ppm or more. When the liquid electrolyte contained in the battery distributed to the market is analyzed, most of dimethyl sulfate may be consumed. Even in such cases, dimethyl sulfate above the detection limit may remain.

When dimethyl sulfate is consumed, as a consequence, a hybrid film derived from LFSI and dimethyl sulfate is formed on the positive electrode surface and the negative electrode surface. Even if dimethyl sulfate cannot be detected from a liquid electrolyte in a battery, an embodiment having a hybrid film derived from LFSI and dimethyl sulfate on a surface of a positive electrode and/or a negative electrode is encompassed by the present invention.

The liquid electrolyte may further include lithium hexafluorophosphate: LiPF₆. At this time, the percentage of LFSI in the sum of LFSI and LiPF₆ may be, for example, not less than 0.5 mass %, not more than 50 mass %, not less than 1 mass %, or not more than 25 mass %. The inclusion of LiPF₆ in the liquid electrolyte improves the quality of LFSI film and improves the capacity maintenance ratios in long-term cycle tests.

The liquid electrolyte may further include lithium difluorophosphate: LiPO₂F₂. The content of lithium difluorophosphate with respect to the mass of the liquid electrolyte may be, for example, 2 mass % or less, and may be 1.5 mass % or less. It is considered that lithium difluorophosphate has an action of forming a good quality film on the surface of the positive electrode active material alone or together with other components of the liquid electrolyte and suppressing excessive side reactions of the liquid electrolyte components. Thus, lithium difluorophosphate contributes to the improvement of the cycle characteristics of the battery.

The ratio of LFSI to the sum of LFSI, LiPF₆ and lithium difluorophosphate may be, for example, 0.5 mass % or more and 50 mass % or less, and may be 1 mass % or more and 25 mass % or less.

The liquid electrolyte may further include lithium fluorosulfonate: LiSO₃F. The content of lithium fluorosulfonate may be, for example, 2 mass % or less with respect to the mass of the liquid electrolyte, and may be 1.5 mass % or less. Lithium fluorosulfonate acts mainly on the negative electrode and may reduce the irreversible capacity of the negative electrode. Among them, when the negative electrode includes a silicate phase and silicon particles dispersed in the silicate phase, lithium fluorosulfonate is utilized for the production of Li₄SiO₄ within the silicate phase. Therefore, lithium ions released from the positive electrode active material are hardly captured by the silicate phase, and the irreversible capacity is reduced.

The liquid electrolyte before injection into the battery or the liquid electrolyte collected from the battery at the initial stage of use may contain, for example, 10 ppm or more of lithium difluorophosphate or lithium fluorosulfonate with respect to the mass of the liquid electrolyte, respectively, and the content of lithium difluorophosphate or lithium fluorosulfonate may be 100 ppm or more, respectively.

Lithium difluorophosphate and lithium fluorosulfonate are increasingly consumed during repeated charge-discharge cycles. Therefore, when the liquid electrolyte contained in the battery distributed in the market is analyzed, most of lithium fluorophosphate and/or lithium fluorosulfonate may be consumed. Even in such a case, lithium fluorophosphate and/or lithium fluorosulfonate above the detection limit may remain.

In addition to the lithium salt described above, the liquid electrolyte may further contain another salt, but the ratio of the total amount of LFSI and LiPF₆ in the lithium salt is preferably 80 mol % or more, more preferably 90 mol % or more. By controlling the ratio of LFSI and LiPF₆ to the above range, it becomes easy to obtain batteries excellent in long-term cycle characteristics.

More specifically, the concentration of the sum of LFSI and LiPF₆ in the liquid electrolyte may be, for example, 1 mol/liter or more and 2 mol/liter or less, and may be 1 mol/liter or more and 1.5 mol/liter or less. Thus, a liquid electrolyte having excellent ion conductivity and moderate viscosity can be obtained.

Lithium salt is usually present in the liquid electrolyte as anions and lithium ions by dissociation. A portion of the lithium salt may be present in the liquid electrolyte in the state of an acid bonded with hydrogen, and may be present in the state of the lithium salt. In other words, the amount of the lithium salt may be calculated as the total amount of the anion derived from the lithium salt, the acid having hydrogen bonded to the anion, and the lithium salt.

The content of dimethyl sulfate and various lithium salts in the liquid electrolyte can be measured, for example, by using gas chromatography-mass spectrometry (GC-MS), nuclear magnetic resonance (NMR), ion chromatography, or the like for the liquid electrolyte.

Next, detailed explanation of a non-aqueous electrolyte secondary battery according to an embodiment of the invention is described. The non-aqueous electrolyte secondary battery includes, for example, a negative electrode, a positive electrode, and a non-aqueous liquid electrolyte as follows.

### [Negative Electrode]

The negative electrode includes, for example, a negative electrode current collector and a negative electrode mixture layer formed on the surface of the negative electrode current collector and containing the negative electrode active material. The negative electrode mixture layer can be formed by applying a negative electrode slurry including a negative electrode mixture dispersed in a dispersion medium, onto a surface of the negative electrode current collector, and drying the applied film. The dried applied film may be rolled, if necessary. The negative electrode mixture layer may be formed on one surface of the negative electrode current collector, or on both surfaces thereof.

The negative electrode mixture contains a negative electrode active material as an essential component, and may contain optional components, such as a binder, an electrically conductive agent, and a thickener. The negative electrode active material includes a material which electrochemically absorbs and releases lithium ions. As a material for absorbing and releasing lithium ions electrochemically, a carbon material, an Si-containing material, or the like can be used. Examples of the Si-containing material include silicon oxides (SiOx: 0.5≤x≤1.5), composite materials containing a silicate phase and silicon particles dispersed in the silicate phase, and the like.

Examples of the carbon material include graphite, graphitizable carbon (soft carbon), and non-graphitizable carbon (hard carbon). Among them, graphite with superior charge and discharge stability and less irreversible capacity is preferred. Graphite means a material having a graphite-type crystal structure, examples of which include natural graphite, artificial graphite, graphitized mesophase carbon particles. The carbon material may be used singly or in combination of two or more.

Among the negative electrode active materials, a composite material containing a silicate phase and silicon particles dispersed in a silicate phase can arbitrarily select the content of silicon particles, so that a high capacity can be easily achieved. Here, the silicate phase is a composite oxide phase containing silicon, oxygen, an alkali metal, or the like. Hereinafter, a composite material in which the silicate phase is a lithium silicate phase containing silicon, oxygen and lithium is also referred to as “LSX”. The higher the content of silicon particles in LSX, the larger the negative electrode capacity. LSX absorbs lithium ions by alloying silicon with lithium. High capacity can be expected by increasing the content of silicon particles. The lithium silicate phase is preferably represented by Li_{y}SiO_{z} (0<y≤8, 0.5≤z≤6). More preferably, lithium silicates whose compositional formula is represented by Li₂ᵤSiO₂₊ᵤ (0<u<2) can be used.

The crystallite size of the silicon particles dispersed in the lithium silicate phase is, for example, 5 nm or more. Silicone particles have a particulate phase of a silicon (Si) simple substance. When the crystallite size of the silicon particle is set at 5 um or more, the surface area of the silicon particle can be kept small, so it is difficult to cause deterioration of the silicon particle in association with the generation of irreversible capacity. The crystallite size of the silicon particles is calculated from the half-width of the diffraction peak assigned to the Si (111) plane of the X-ray diffraction (XRD) pattern of the silicon particles by the equation of Sheller.

As the negative electrode active material. LSX and a carbon material may be used in combination. LSX expands and contracts in volume with charge and discharge. Therefore, when the ratio of LSX occupied in the negative electrode active material increases, the contact failure between the negative electrode active material and the negative electrode current collector is likely to occur with charge and discharge. On the other hand, the combination of LSX with a carbon material enables to achieve excellent cycle characteristics while giving high capacity of silicon particles to the negative electrode. The ratio of LSX to the sum of LSX and the carbon material is preferably 3 to 30 mass %, for example. This makes it easy to achieve both higher capacity and improved cycle characteristics.

As the negative electrode current collector, a metal foil, a mesh body, a net body, a punched sheet, and the like are used. The negative electrode current collector may be made of, for example, stainless steel, nickel, a nickel alloy, copper, and a copper alloy.

### [Positive Electrode]

The positive electrode includes, for example, a positive electrode current collector, and a positive electrode mixture layer formed on a surface of the positive electrode current collector. The positive electrode mixture layer can be formed by applying a positive electrode slurry comprising a positive electrode mixture dispersed in a dispersion medium, onto a surface of the positive electrode current collector, and drying the applied film. The dried applied film may be rolled, if necessary. The positive electrode mixture layer may be formed on one surface of the positive electrode current collector, and may be formed on both surfaces.

The positive electrode mixture includes a positive electrode active material as an essential component, and may include a binder, a conductive agent, and the like as an optional component. The positive electrode active material includes a material which electrochemically absorbs and releases lithium ions. As a material for absorbing and releasing lithium ions electrochemically, a layered compound of a rock salt type crystal structure containing lithium and a transition metal, a spinel compound containing lithium and a transition metal, a polyanion compound, and the like are used. Among them, a layered compound is preferred.

Layered compounds include LiₐCoO₂, Li₃NiO₂, LiₐMnO₂, LiₐCo_{b}Ni_{1-b}O₂, LiₐCo_{b}M_{1-b}O_{c}, LiₐNi_{b}M_{1-b}O_{c}, and the like. Among them, a composite oxide containing lithium and nickel and represented by the general formula: LiₐNi_{b}M_{1-b}O₂ is preferred in terms of expressing a high capacity. However, the higher the nickel content in the composite oxide, the higher the alkalinity of the composite oxide and the higher the reactivity with LFSI. On the other hand, when dimethyl sulfate is contained in the liquid electrolyte, excessive reaction of LFSI is suppressed due to formation of a hybrid film.

Here, M is a metal and/or a semi-metal other than Li and Ni, meeting 0.95≤a≤1.2, and 0.6≤b≤1. Values of “a” are those in the positive electrode active material in the fully discharged state, which increases or decreases due to charge and discharge. From the viewpoint of obtaining a higher capacity, it is preferable that the above general formula satisfies 0.85≤b≤1, and more preferably satisfies 0.9≤b<1 or 0.9≤b≤0.98.

M is preferably at least one selected from the group consisting of, but not limited to, Na, Mg, Sc, Y, Mn, Fe, Co, Cu, Zn, Al, Cr, Pb, Sb and B. M may be at least one selected from the group consisting of, for example, Mn, Fe, Co, Cu, Zn and Al, preferably including at least one selected from the group consisting of Mn, Co and Al among them.

As the positive electrode current collector, for example, a metal foil is used, and as the material, stainless steel, aluminum, aluminum alloy, titanium or the like can be exemplified.

Examples of the binder of each electrode include a resin material, for example, a fluororesin such as polytetrafluoroethylene or polyvinylidene fluoride (PVDF); a polyolefin resin such as polyethylene or polypropylene: a polyamide resin such as an aramid resin; a polyimide resin such as polyimide or polyamideimide; an acrylic resin such as polyacrylic acid, polyacrylic acid salt (e.g., lithium polyacrylate), polymethylacrylate, ethylene-acrylic acid copolymer: a vinyl resin such as polyacrylonitrile or polyvinyl acetate; polyvinylpyrrolidone: a rubbery material such as a styrene-butadiene copolymer rubber (SBR), and the like. These may be used singly or in combination of two or more. Among them, acrylic resins exert a high binding force to Si-containing materials.

Note that Si-containing materials are prone to increase the internal resistance because of large expansion and contraction during charge and discharge, and the cycle characteristics are also prone to decrease. On the other hand, by using an acrylic resin as a binder and allowing the liquid electrolyte contain LFSI, an increase in internal resistance and a decrease in cycle characteristics are greatly suppressed. This is because, when a liquid electrolyte containing LFSI is immersed in a negative electrode containing an acrylic resin, swelling of the acrylic resin is suppressed, and a high degree of binding force of the acrylic resin is maintained, and an increase in contact resistance between the negative electrode active material particles and between the negative electrode active material particles and the negative electrode current collector is suppressed. The acrylic resin may be, for example, 1.5 parts by mass or less per 100 parts by mass of the negative electrode active material, and may be 0.4 parts by mass or more and 1.5 parts by mass or less.

Examples of the conductive agent include: carbon blacks, such as acetylene black: conductive fibers, such as carbon fibers and metal fibers: fluorinated carbon; metal powders, such as aluminum; conductive whiskers, such as zinc oxide and potassium titanate; conductive metal oxides, such as titanium oxide: and organic conductive materials, such as phenylene derivatives. These may be used singly or in combination of two or more.

Examples of the thickener include: carboxymethyl cellulose (CMC) and modified products thereof (including salts such as Na salt); cellulose derivatives (e.g., cellulose ether), such as methyl cellulose; saponified products of a polymer having a vinyl acetate unit, such as polyvinyl alcohol; polyether (e.g., polyalkylene oxide, such as polyethylene oxide). These may be used singly or in combination of two or more.

The dispersion medium is not particularly limited, and examples thereof include water, an alcohol, and N-methyl-2-pyrrolidone (NMP).

### [Liquid Electrolyte]

The liquid electrolyte usually includes a lithium salt, a solvent and an additive. Various additives may be included in the liquid electrolyte. In the liquid electrolyte, it is preferable that the total amount of the lithium salt and the solvent occupies 90 mass % or more, more preferably 95 mass % or more, of the liquid electrolyte.

Used as the solvent are a cyclic carbonic acid ester, a cyclic carboxylic acid ester, a chain carbonic acid ester and a chain carboxylic acid ester, and an electrolyte component which exhibits a liquid state at 25° C. and is contained in the liquid electrolyte in an amount of 3 mass % or more. One or more of these solvents may be used in any combination.

Examples of the cyclic carbonic acid ester include propylene carbonate (PC), ethylene carbonate (EC), fluoroethylene carbonate (FEC), vinylene carbonate (VC), and vinyl ethylene carbonate (VEC).

Examples of the chain carbonic acid ester include diethyl carbonate (DEC), ethyl methyl carbonate (EMC), and dimethyl carbonate (DMC).

Examples of the chain carboxylic acid ester include methyl formate, ethyl formate, methyl acetate, ethyl acetate, and methyl propionate. Among them, methyl acetate is highly stable and low in viscosity, which may improve the low-temperature characteristics of the battery. The content of methyl acetate in the liquid electrolyte may be, for example, 3 mass % or more and 20 mass % or less.

Examples of the cyclic carboxylic acid ester include γ-butyrolactone (GBL) and γ-valerolactone (GVL).

Note that a polymer which alone exhibits a solid state at 25° C. is not included in the liquid electrolyte component even when the content thereof in the electrolyte is 3 mass % or more. Such a polymer functions as a matrix for gelling a liquid electrolyte.

Examples of the additive include a carboxylic acid, an alcohol, 1,3-propanesultone, methylbenzenesulfonate, cyclohexylbenzene, biphenyl, diphenyl ether, and fluorobenzene.

The liquid electrolyte may contain, in addition to the lithium salt already mentioned, yet another salt. Other salts include LiClO₄, LiAICl₄, LiB₁₀Cl₁₀, LiBF₄, LiSbF₆, LiAsF₆, LiCF₃SO₃, LiCF₃CO₂, LiN(CF₃SO₂)₂, LiN(CF₃SO₂)(C₄F₉SO₂), LiN(C₂F₅SO₂)₂, LiCl, LiBr, and LiI. One or more of the lithium salts may be used in any combination.

### [Separator]

It is desirable to interpose a separator between the positive electrode and the negative electrode. The separator is excellent in ion permeability and has moderate mechanical strength and electrically insulating properties. The separator may be, for example, a microporous thin film, a woven fabric, or a nonwoven fabric. The separator is preferably made of, for example, polyolefin, such as polypropylene or polyethylene.

Examples of the structure of the non-aqueous electrolyte secondary battery include a structure in which an electrode group including the positive and negative electrodes wound together with a separator interposed therebetween, and a non-aqueous liquid electrolyte are housed in an external material. The wound-type electrode group may be replaced with a different form of electrode group, for example, a stacked-type electrode group formed by stacking a positive electrode and a negative electrode with a separator interposed therebetween. Non-aqueous electrolyte secondary batteries may be in any form, such as cylindrical, rectangular, coin, button, laminated, and the like.

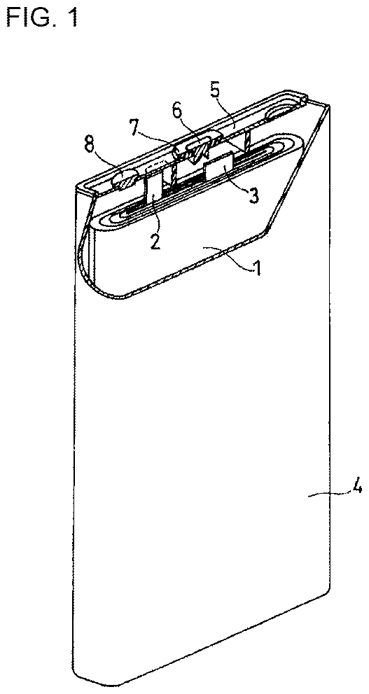

FIG. 1 is a schematic partially cut-away oblique view of a rectangular non-aqueous electrolyte secondary battery according to one embodiment of the invention.

The battery is equipped with a bottomed-square battery case 4 and electrode group 1 and a non-aqueous liquid electrolyte (not shown) housed within battery case 4. Electrode group 1 has a longitudinal band-like negative electrode and a longitudinal band-like positive electrode with an intervening separator between them. Electrode group 1 is formed by winding the negative electrode, positive electrode and the separator around a flat winding core and withdrawing the winding core.

One end of negative electrode lead 3 is attached to the negative electrode current collector of the negative electrode by welding or the like. One end of positive electrode lead 2 is attached to the positive electrode current collector of the positive electrode by welding or the like. The other end of negative electrode lead 3 is electrically connected to the negative terminal 6 provided on sealing plate 5 through gasket 7. The other end of positive electrode lead 2 is electrically connected to battery case 4 which also serves as a positive terminal. At the top of electrode group 1 disposed is a resin frame that separates electrode group 1 and sealing plate 5 as well as separates negative electrode lead 3 and battery case 4. The opening of battery case 4 is sealed with sealing plate 5.

The structure of the non-aqueous electrolyte secondary battery may be a cylindrical, coin-shaped, button-shaped or the like having a metal battery case, and may be a laminate type having a laminate sheet battery case made of a laminated body of a barrier layer and a resin sheet.

The present invention will be specifically described below with reference to Examples and Comparative Examples. The present invention, however, is not limited to the following Examples.

### Examples 1 to 3 and Comparative Examples 1 to 3

### [Preparation of LSX]

Silicon dioxide and lithium carbonate were mixed so that the atomic ratio: Si/Li was 1.05, and the mixture was calcined in air at 950° C. for 10 hours to obtain a lithium silicate represented by the formula: Li₂Si₂O₅ (u=0.5). The obtained lithium silicate was pulverized so as to have an average particle diameter of 10 μm.

The lithium silicate (Li₂Si₂O₅) having an average particle diameter of 10 μm and raw material silicon (3N, average particle diameter: 10 μm) were mixed at a mass ratio of 45:55. The mixture was introduced into a pot (made of SUS, volume: 500 mL) of a planetary ball mill (P-5, manufactured by Fritsch Japan Co., Ltd.) and 24 balls made of SUS (diameter: 20 mm) were placed in the pot, and the lid thereof was closed. Then, the mixture was subjected to a grinding treatment at 200 rpm for 50 hours in an inert atmosphere.

Then, the powder-like mixture was collected in an inert atmosphere, and the mixture was fired at 800° C. for 4 hours with a pressure applied by a hot press machine in an inert atmosphere to obtained a sintered material (LSX).

Subsequently. LSX was crushed and passed through a 40-μm mesh, then the resulting LSX particles were mixed with coal pitch (MCP 250, manufactured by JE Chemical Co., Ltd.). The obtained mixture was calcined in an inert atmosphere at 800° C., and the surface of LSX particles was coated with a conductive carbon to form a conductive layer. Coating amount of the conductive layer was 5 mass % with respect to the total mass of the LSX particles and the conductive layer. Subsequently, using a sieve. LSX particles with conductive layers with an average particle diameter of 5 μm were obtained.

### [Preparation of Negative Electrode]

LSX particles with the conductive layer were mixed with graphite at a mass ratio of 3:97 and used as negative electrode active materials. The negative electrode active materials, lithium polyacrylate, and a styrene-butadiene rubber (SBR) were mixed in a mass ratio of 97.5:1:1.5, added with water, and then stirred using a mixer (T.K. HIVIS MIX, manufactured by PRIMIX Corporation) to prepare a negative electrode slurry. Next, the negative electrode slurry was applied to the surface of a copper foil, and the applied film was dried, and then rolled to give a negative electrode having a negative electrode mixture layer of a density of 1.5 g/cm³ formed on both sides of the copper foil.

### [Preparation of Positive Electrode]

A lithium nickel composite oxide (LiNi_{0.8}Co_{0.18}A_{0.02}O₂), acetylene black, and polyvinylidene fluoride were mixed at a mass ratio of 95:2.5:2.5, added with N-methyl-2-pyrrolidone (NMP), and then stirred using a mixer (T.K. HIVIS MIX, manufactured by PRIMIX Corporation) to prepare a positive electrode slurry. Next, the positive electrode slurry was applied to the surface of an aluminum foil, and the applied film was dried, and then rolled to give a positive electrode having positive electrode mixture layers of a density of 3.6 g/cm³ formed on both sides of the aluminum foil.

### [Preparation of Non-Aqueous Liquid Electrolyte]

As the solvent, a mixed solvent containing ethylene carbonate (EC), dimethyl carbonate (DMC) and methyl acetate (MA) at a volume ratio of 20:70:10 was used. In the mixed solvent, LFSI and LiPF₆ were dissolved at the ratios shown in Table 1. In addition, in the liquid electrolyte, dimethyl sulfate was contained at the content shown in Table 1, and lithium difluorophosphate and lithium fluorosulfonate were contained in an amount of 1 mass %, respectively.

### [Fabrication of Non-Aqueous Electrolyte Secondary Battery]

The positive electrode and the negative electrode, with a tab attached to each electrode, were wound spirally with a separator interposed therebetween such that the tabs were positioned at the outermost layer, thereby to form an electrode group. The electrode group was inserted into an external material made of aluminum laminate film, vacuum-dried at 105° C. for 2 hours, followed by injection of the non-aqueous liquid electrolyte and sealing the opening of the external material to obtain Batteries A1 to A3 of Examples 1 to 3 and Batteries B1 to B3 of Comparative Examples 1 to 3.

### [Evaluation]

Each battery after fabrication, in an ambient of 25° C., was subjected to constant current charge until the voltage became 4.2 V at a current of 0.3 It (1620 mA), then constant voltage charge until the current became 0.05 It at a constant voltage of 4.2 V After a 20-min rest, constant current discharge was made until the voltage reached 2.5 V at 0.5 It currents. This charge and discharge were repeated twice. Thereafter, constant current charge was performed with a current of 0.3 It (1620 mA) until the voltage reached 3.748 V, and then constant voltage charge was performed at a constant voltage of 3.748 V until the current reached 10 mA, thereby setting the state-of-charge (SOC) of the batteries to 50%.

Then, impedance of the battery was measured by applying an AC voltage amplitude of 10 mV in an environment of 25° C. Table 1 shows the relative values of the impedances of batteries A2 to A3 and B1 to B3 when the impedance of Battery A1 is set as 1.

Thereafter, the battery was taken out and decomposed, and the components of the liquid electrolyte were analyzed by gas chromatography-mass spectrometry (GC-MS), and it was also confirmed that the liquid electrolyte of batteries A1 to A3 contained almost the same amount of LiPF₆ as the initial amount at preparation, and that LFSI, lithium difluorophosphate, and lithium fluorosulfonate and dimethyl sulfate were present.

The measuring conditions of GC-MS used for analyzing the liquid electrolyte are as follows.

Equipment: GC17A, GCMS-QP5050A manufactured by Shimadzu Corporation.

Columns: HP-1 (1.0 μm membrane thickness×60 m length) manufactured by Agilent Technologies, Inc.

Column temperature: 50° C.→110° C. (5° C./min, 12 min hold)→250° C. (5° C./min, 7 min hold)→300° C. (10° C./min. 20 min hold)

Split ratio: 1/50

Linear velocity: 29.2 cm/s

Injection port temperature: 270° C.

Injection volume: 0.5 μL

Interface temperature: 230° C.

Mass range: m/z=60-100 (SCAN mode)

TABLE 1

| | | | Dimethyl | | | |
|---|---|---|---|---|---|---|
| | LFSI | LiPF₆ | sulfate | | LFSI/ | Impedance |
| Battery | (M) | (M) | (mass %) | solvent | (LFSI + LiPF₆) | (SOC50%) |
| A1 | 0.3 | 1.0 | 1 | EC/DMC/MA | 0.27 | 1.00 |
| A2 | 0.05 | 1.3 | 1 | EC/DMC/MA | 0.05 | 1.03 |
| A3 | 0.7 | 0.6 | 1 | EC/DMC/MA | 0.59 | 1.05 |
| B1 | 0 | 1.3 | 1 | EC/DMC/MA | 0 | 1.10 |
| B2 | 0.3 | 1.0 | — | EC/DMC/MA | 0.27 | 1.19 |
| B3 | 0 | 1.3 | — | EC/DMC/MA | 0 | 1.22 |

### Examples 4 to 6

Liquid electrolytes were prepared in the same manner as in Example 1, except that the amounts of lithium difluorophosphate and lithium fluorosulfonate were changed as shown in Table 1, and batteries A4 to A6 of Examples 4 to 6 were prepared and evaluated in the same manner as described above. Table 2 shows the relative values of the impedances of batteries A1, A4, and A5 when the impedance of battery A6 is set as 1.

TABLE 2

| | | | | Lithium | Lithium | |
|---|---|---|---|---|---|---|
| | | | Dimethyl | difluoro- | fluoro- | |
| | LFSI | LiPF₆ | sulfate | phosphate | sulfonate | Impedance |
| Battery | (M) | (M) | (mass %) | (mass %) | (mass %) | (SOC50%) |
| A1 | 0.3 | 1.0 | 1 | 1 | 1 | 0.92 |
| A4 | 0.3 | 1.0 | 1 | 1 | — | 0.96 |
| A5 | 0.3 | 1.0 | 1 | — | 1 | 0.98 |
| A6 | 0.3 | 1.0 | 1 | — | — | 1.00 |

### Comparative Example 4

A battery B4 of Comparative Example 4 was prepared in the same manner as in Example 1, except that no LFSI was used in the preparation of the liquid electrolyte, and instead, lithium bis(trifluoromethylsulfonyl)imide (LTFSI) was used, and evaluated in the same manner. Table 3 shows the relative impedance of Battery B4 when the impedance of Battery A1 is set as 1.

### Examples 7

A battery A7 of Example 7 was prepared in the same manner as in Example 1, except that, in the preparation of the negative electrode. LSX was not used and graphite, carboxy methylcellulose, and styrene-butadiene rubber (SBR) were mixed in a mass ratio of 97.5:1:1.5 to prepare a negative electrode slurry, and evaluated in the same manner. Table 3 shows the relative impedance of Battery A7 when the impedance of Battery A1 is set as 1.

TABLE 3

| | LFSI | LTFSI | LiPF₆ | | | Impedance |
|---|---|---|---|---|---|---|
| Battery | (M) | (M) | (M) | Graphite | LSX | (SOC50%) |
| A1 | 0.3 | — | 1.0 | 97 | 3 | 1.00 |
| B4 | — | 0.3 | 1.0 | 97 | 3 | 1.15 |
| A7 | 0.3 | | 1.0 | 100 | 0 | 1.30 |

The reason why the impedance of battery A7 is larger than that of battery A1 is considered to be that, when the negative electrode does not include LSX, the hybrid film formed on the surface of the negative electrode becomes thicker than when the negative electrode includes LSX. It is presumed that if the negative electrode contains LSX, new surfaces are formed due to expansion and contraction of LSX during charge and discharge, so that a dimethyl sulfate-derived electron conductivity-rich film is more likely to be formed and the film is less likely to thicken than without LSX.

### INDUSTRIAL APPLICABILITY

According to the present invention, it is possible to provide a non-aqueous electrolyte secondary battery having a small initial impedance. The non-aqueous electrolyte secondary battery of the invention is useful for the main power sources of mobile communication devices, mobile electronic devices, and the like.

### REFERENCE SIGNS LIST

1: electrode group
2: positive electrode lead
3: negative electrode lead
4: battery case
5: sealing plate
6: negative terminal
7: gasket

1. A non-aqueous electrolyte secondary battery comprising: a positive electrode, a negative electrode and a liquid electrolyte,
wherein the liquid electrolyte includes lithium bis(fluorosulfonyl)imide and dimethyl sulfate.

2. The non-aqueous electrolyte secondary battery according to claim 1,
wherein the liquid electrolyte further contains lithium hexafluorophosphate, and
a ratio of lithium bis(fluorosulfonyl)imide to a total of lithium bis(fluorosulfonyl)imide and lithium hexafluorophosphate is 5 mass % or more and 50 mass % or less.

3. The non-aqueous electrolyte secondary battery according to claim 1,
wherein the liquid electrolyte further contains lithium difluorophosphate, and
a content of lithium difluorophosphate is 2 mass % or less with respect to a mass of the liquid electrolyte.

4. The non-aqueous electrolyte secondary battery according to claim 1,
wherein a total concentration of lithium bis(fluorosulfonyl)imide and lithium hexafluorophosphate in the liquid electrolyte is 1 mol/liter or more and 2 mol/liter or less.

5. The non-aqueous electrolyte secondary battery according to claim 1,
wherein the liquid electrolyte further contains lithium fluorosulfonate, and
a content of lithium fluorosulfonate is 2 mass % or less with respect to a mass of the liquid electrolyte.

6. The non-aqueous electrolyte secondary battery according to claim 1,
wherein the negative electrode includes a silicate phase and silicon particles dispersed in the silicate phase.

7. A liquid electrolyte for a non-aqueous electrolyte secondary battery containing lithium bis(fluorosulfonyl)imide and dimethyl sulfate.
